(19) United States
(12) Patent Application Publication
(10) Pub. No.: US 2007/0177915 A1
(43) Pub. Date: Aug. 2, 2007

(54) PAPER CASSETTE

(75) Inventor: Kouichi MOTOYOSHI, Kyoto-shi (JP)

Correspondence Address: MURATA MACHINERY, LTD.;(MURATEC) c/o KEATING & BENNETT LLP, 8180 GREENSBORO DRIVE, SUITE 850, MCLEAN, VA, 22102, US

(73) Assignee: MURATA KIKAI KABUSHIKI KAISHA, Fushimi-ku, Kyoto (JP)

(21) Appl. No.: 11/619,756

(22) Filed: Jan. 4, 2007

(30) Foreign Application Priority Data
Jan. 30, 2006 (JP) 2006-021564

(51) Int. Cl. G03G 15/00

(52) U.S. Cl. 399/393

(57) ABSTRACT

On an upper side of a protruding portion provided on a front surface of a paper cassette, a first gripper is disposed so as to enable a user to place a finger on a first pressure portion of the first gripper and pull out the paper cassette easily. Compared to a paper cassette with a first gripper disposed on an underside of a protruding portion, the first gripper is provided on the upper side of the protruding portion in the paper cassette of the present invention such that the user can easily pull out the paper cassette without bending over deeply.

### BACKGROUND OF THE INVENTION

1. Field of the Invention

The present invention relates to a paper cassette which stores paper therein and is used in an image forming device.

2. Description of the Related Art

Some conventional image forming devices have a paper cassette in which paper is stored. On a front surface of the paper cassette, a forwardly protruding gripper is formed. On an underside of the gripper, a concave portion is formed to enable a user to place a finger therein. The user places the finger in the concave portion formed on the underside of the gripper and pulls the gripper forward to pull out the paper cassette.

With a design having the concave portion on the underside of the gripper, the concave portion is located on the underside. Therefore, in order to pull out the paper cassette, the user is required to bend over to open and close the paper cassette. This bent-over posture has been a considerable burden for users with an injured or handicapped lower back.

In particular, in case of a large image forming device, a bottom paper cassette is located close to the floor. As a result, the user is required to bend over fully to open and close the paper cassette, causing more concern about the above-described problems.

### SUMMARY OF THE INVENTION

In order to overcome the problems described above, preferred embodiments of the present invention provide a paper cassette which can be easily opened and closed without requiring a user to fully bend over.

A first preferred embodiment of the present invention includes a paper cassette which stores paper therein and is used in an image forming device. A protruding portion is provided on a front surface of the paper cassette. A first gripper is formed on an upper side of the protruding portion to enable a user to place a finger in the first gripper and pull out the paper cassette.

According to the first preferred embodiment of the present invention, the first gripper is provided on the upper side of the protruding portion provided on the front surface of the paper cassette to enable the user to place the finger in the first gripper and pull out the paper cassette. Therefore, the user can easily pull out the paper cassette by placing the finger in the first gripper and pulling the first gripper forward. Compared to a paper cassette with a first gripper formed on an underside of a protruding portion, the first gripper is disposed on the upper side of the protruding portion in the paper cassette according to a preferred embodiment of the present invention such that the user can easily pull out the paper cassette according to a preferred embodiment of the present invention without bending over deeply. In particular, even when the paper cassette is located at a low level close to the floor, a physical burden on the user caused by pulling out the paper cassette can be considerably reduced.

According to a second preferred embodiment of the present invention, a second gripper is provided on an underside of the protruding portion to enable the user to place the finger in the second gripper and pull out the paper cassette.

According to the second preferred embodiment of the present invention, the second gripper is provided on the underside of the protruding portion to enable the user to place the finger in the second gripper and pull out the paper cassette. Therefore, a relatively short user or a user in a low position, for example, a user sitting on the floor, can also pull out the paper cassette easily by placing the finger in the second gripper provided on the underside of the protruding portion.

According to a third preferred embodiment of the present invention, the first gripper and the second gripper are concave.

According to the third preferred embodiment of the present invention, since the first gripper and the second gripper have a concave configuration, the first gripper and the second gripper do not form a through-hole that penetrates vertically through the protruding portion. Therefore, it is possible to achieve a prescribed rigidity of the paper cassette, especially of the protruding portion, as well as to prevent impairing the design of the paper cassette. When a mold is used to shape the paper cassette, since the first gripper and the second gripper are concavely formed, the paper cassette can be easily removed from the mold.

According to a fourth preferred embodiment of the present invention, the protruding portion, the first gripper, and the second gripper are integrally molded of resin or plastic, or any other suitable material. A resin or plastic thickness of a first pressure portion, where a force of the finger acts upon when the finger is placed in the first gripper to pull out the paper cassette, is substantially the same as a resin or plastic thickness of a second pressure portion, where a force of the finger acts upon when the finger is placed in the second gripper to pull out the paper cassette.

According to the fourth preferred embodiment of the present invention, since both the first pressure portion and the second pressure portion have substantially the same resin or plastic thickness, the rigidity of the first pressure portion and the second pressure portion can be kept substantially the same. In addition, by reducing the resin or plastic thickness of both the first pressure portion and the second pressure portion, an amount of resin or plastic used can be reduced. As a result, the paper cassette can be manufactured economically.

In a fifth preferred embodiment of the present invention, a depth of the first gripper is shallower than a depth of the second gripper.

According to the fifth preferred embodiment of the present invention, since the depth of the concave first gripper is shallower than the depth of the concave second gripper, the depth of the second gripper located below the first gripper can be deeper. Therefore, other components, such as a lock lever, can be mounted inside the second gripper. In addition, dust and dirt accumulated in the first gripper over a long period of use can be easily removed.

According to various preferred embodiments of the present invention, the user can easily open and close the paper cassette without bending over fully.

Other features, elements, processes, steps, characteristics and advantages of the present invention will become more apparent from the following detailed description of preferred embodiments of the present invention with reference to the attached drawings.

### BRIEF DESCRIPTION OF THE DRAWINGS

FIG. 1 is a perspective view of an image forming device having paper cassettes according to a preferred embodiment of the present invention.

FIG. 2 is an enlarged view of the paper cassettes according to a preferred embodiment of the present invention.

FIG. 3 is a partial cross sectional view of a paper cassette according to a preferred embodiment of the present invention.

### DETAILED DESCRIPTION OF PREFERRED EMBODIMENTS

A description will be made of a paper cassette according to preferred embodiments of the present invention with reference to the drawings.

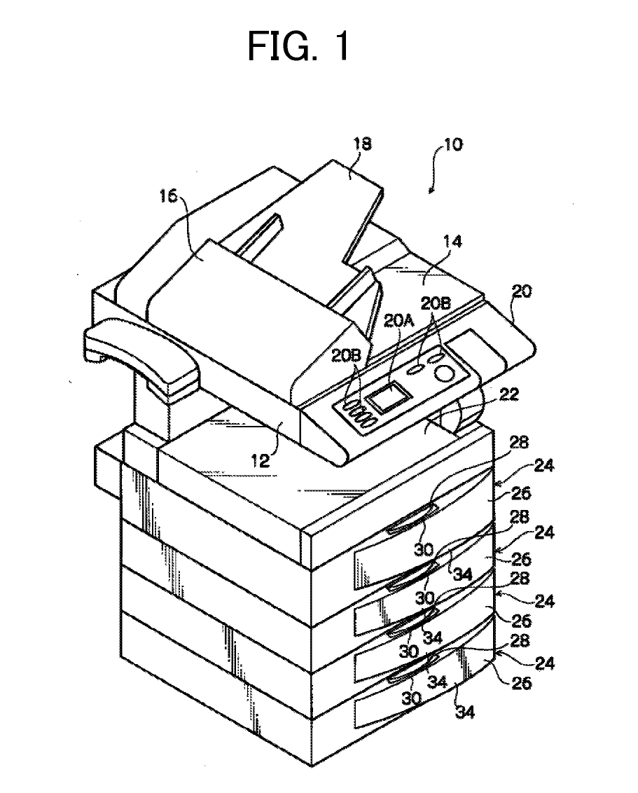

A description will be made of an overall structure of an image forming device having paper cassettes according to preferred embodiments of the present invention. As illustrated in FIG. 1, an image forming device 10 includes a document table 12. A cover member 14, which opens and closes the document table 12, is mounted on an upper surface of the document table 12. An original document is placed on the document table 12. Then, the document table 12 is covered by the cover member 14, and a copy of the original document is made. The cover member 14 is mounted with an Auto Document Feeder (ADF) 16. The ADF 16 is mounted with a paper feed tray 18. An original document placed on the paper feed tray 18 is supplied to the ADF 16. The supplied original document is then ejected from the ADF 16 and stacked on an upper surface of the cover member 14.

An operation panel 20 is mounted on the document table 12. A liquid crystal display 20A, which displays prescribed information, and a plurality of input buttons 20B are mounted on the operation panel 20. A copy receiving tray 22 is arranged below the document table 12. After prescribed information is printed onto paper, the paper is ejected onto the copy receiving tray 22.

A plurality of paper cassettes 24 (four paper cassettes 24 in the present preferred embodiment, for example) are provided below the copy receiving tray 22. The paper cassettes 24 store different sized papers respectively.

Next, a description will be made of the paper cassette 24.

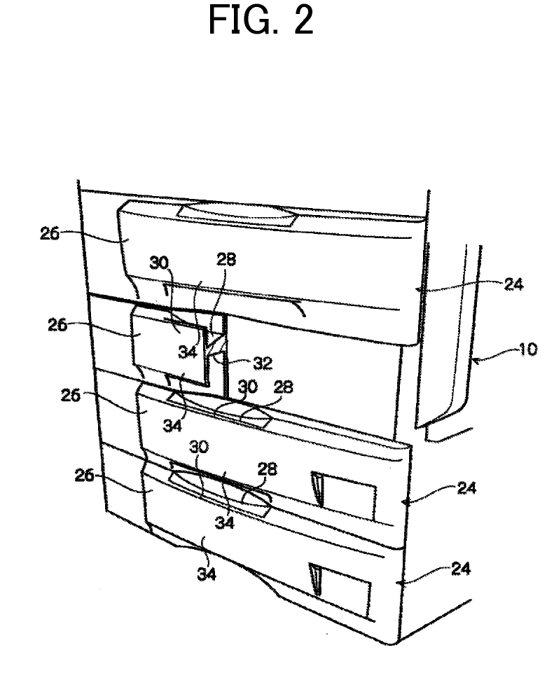

As illustrated in FIGS. 1 and 2, the paper cassette 24 has a box-shaped portion, and a forwardly protruding portion 26 is formed on a front surface of the box-shaped portion. A concave first gripper 28 is provided on an upper side of the protruding portion 26. Between the first gripper 28 and the front surface of the protruding portion 26, a first pressure portion 30 having a prescribed thickness is provided. A force of a finger acts directly upon the first pressure portion 30 when the user places the finger in the first gripper 28 and pulls out the paper cassette 24.

As illustrated in FIG. 2, a concave second gripper 32 is formed on an underside of the protruding portion 26. Between the second gripper 32 and the front surface of the protruding portion 26, a second pressure portion 34 having a prescribed thickness is formed. A force of a finger acts directly upon the second pressure portion 34 when the user places the finger in the second gripper 32 and pulls out the paper cassette 24.

A depth of the concave first gripper 28 is preferably shallower than a depth of the concave second gripper 32. Accordingly, the depth of the second gripper 32 located below the first gripper 28 can be deeper. As a result, other components, such as a lock lever, can be mounted in the second gripper 32. In addition, dirt and dust accumulated over a long period of use can be removed easily.

The entire paper cassette 24 is preferably formed of resin, plastic or other suitable material. In other words, the protruding portion 26, the first gripper 28, the second gripper 32, the first pressure portion 30, and the second pressure portion 34 are preferably integrally formed by pouring resin or plastic in a prescribed mold and heating the resin or plastic.

As described above, the first gripper 28 is formed on the upper side of the protruding portion 26, the second gripper 32 is formed on the underside of the protruding portion 26, and the first gripper 28 and the second gripper 32 are concavely formed. Thus, the first gripper 28 and the second gripper 32 do not form a through-hole that penetrates vertically through the protruding portion 26.

Both the first pressure portion 30 and the second pressure portion 34 have substantially the same resin or plastic thickness.

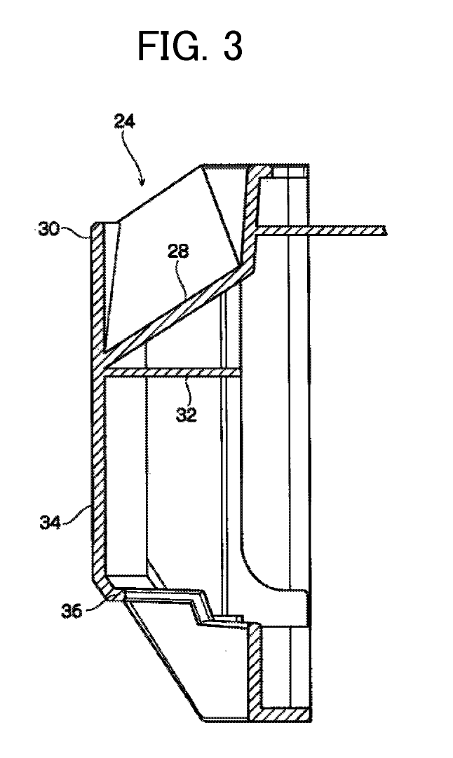

As illustrated in FIG. 3, a top edge of the first pressure portion 30 is located lower in a vertical direction than a portion at an opposite side (inner side) of the front surface of the paper cassette 24. Accordingly, an opening of the concave first gripper 28 can be widely formed so that the user can easily insert the finger in the first gripper 28. The user can also insert a finger in the first gripper 28 reliably on a back side of the first gripper 28. As a result, when pulling out the paper cassette 24, the user can easily strengthen the force of the grip of the finger on the back side of the first gripper 28.

In addition, as illustrated in FIG. 3, a hooking portion 36 is formed on a bottom edge of the second pressure portion 34. The user can hook a finger on the hooking portion 36. By hooking the finger on the hooking portion 36, the user can easily strengthen the force of the grip of the finger when pulling out the paper cassette 24.

Next, a description will be made of an effect of the paper cassette 24 according to a preferred embodiment of the present invention.

As illustrated in FIGS. 1 and 2, since the first gripper 28 is provided on the upper side of the protruding portion 26 provided on the front surface of the paper cassette 24, the user can easily pull out the paper cassette 24 by placing the finger on the first pressure portion 30 of the first gripper 28 and pulling the first gripper 28 forward. Compared to a structure in which a first gripper 28 is provided on an underside of a protruding portion 26, the first gripper 28 is provided on the upper side of the protruding portion 26 in the above-described preferred embodiment such that the user can easily pull out the paper cassette 24 without bending over deeply. In particular, even when the paper cassette 24 is located at a low level close to the floor, a physical burden on the user caused by pulling out the paper cassette 24 can be considerably reduced.

Since the second gripper 32 is provided on the underside of the protruding portion 26, a relatively short user or a user in a low position, for example, a user sitting on the floor, can also easily pull out the paper cassette 24 by placing a finger on the second pressure portion 34 of the second gripper 32 provided on the underside of the protruding portion 26.

Since the first gripper 28 and the second gripper 32 have the concave configuration, the first gripper 28 and the second gripper 32 do not form a through-hole that penetrates vertically through the protruding portion 26. Accordingly, it is possible to achieve a prescribed rigidity of the paper cassette 24, especially of the protruding portion 26, as well as to prevent impairing or limiting the design of the paper cassette 24. When a mold is used to shape the paper cassette 24, since the first gripper 28 and the second gripper 32 are concavely formed, the paper cassette 24 can be easily removed from the mold.

The resin or plastic thickness of the first pressure portion 30, where the force of the finger acts upon when the finger is placed in the first gripper 28 to pull out the paper cassette 24, is substantially the same as the resin or plastic thickness of the second pressure portion 34, where the force of the finger acts upon when the finger is placed in the second gripper 32 to pull out the paper cassette 24. As a result, the rigidity of the first pressure portion 30 and the second pressure portion 34 can be kept substantially the same. In addition, by reducing the resin or plastic thickness of both the first pressure portion 30 and the second pressure portion 34, an amount of resin or plastic used can be reduced. As a result, the paper cassette 24 can be manufactured economically.

While the present invention has been described with respect to preferred embodiments thereof, it will be apparent to those skilled in the art that the disclosed invention may be modified in numerous ways and may assume many embodiments other than those specifically set out and described above. Accordingly, the appended claims are intended to cover all modifications of the present invention that fall within the true spirit and scope of the present invention.

What is claimed is:

1. A paper cassette in an image forming device, comprising:
a box-shaped portion in which paper is stored;
a protruding portion arranged on a front surface of the box-shaped portion; and
a first gripper arranged on an upper side of the protruding portion such that a finger of a user can be placed to pull out the paper cassette.

2. The paper cassette according to claim 1, further comprising a second gripper arranged on an underside of the protruding portion such that the finger of the user can be placed so as to pull out the paper cassette.

3. The paper cassette according to claim 2, wherein the first gripper and the second gripper have a concave shape.

4. The paper cassette according to claim 2, wherein the protruding portion, the first gripper, and the second gripper are integrally formed of resin or plastic, and a thickness of the resin or plastic of a first pressure portion, where a force of the finger acts upon when the finger is placed in the first gripper, is substantially the same as a thickness of the resin or plastic of a second pressure portion, where a force of the finger acts upon when the finger is placed in the second gripper.

5. The paper cassette according to claim 3, wherein the protruding portion, the first gripper, and the second gripper are integrally formed of resin or plastic, and a thickness of the resin or plastic of a first pressure portion, where a force of the finger acts upon when the finger is placed in the first gripper, is substantially the same as a thickness of the resin or plastic of a second pressure portion, where a force of the finger acts upon when the finger is placed in the second gripper.

6. The paper cassette according to claim 3, wherein a depth of the first gripper is shallower than a depth of the second gripper.

7. The paper cassette according to claim 4, wherein a depth of the first gripper is shallower than a depth of the second gripper.

8. The paper cassette according to claim 5, wherein a depth of the first gripper is shallower than a depth of the second gripper.
